(19) United States
(12) Patent Application Publication
(10) Pub. No.: US 2018/0264361 A1
(43) Pub. Date: Sep. 20, 2018

(54) WEB PAGE RUNNING METHOD AND APPARATUS, TERMINAL, AND STORAGE MEDIUM

(71) Applicant: TENCENT TECHNOLOGY (SHENZHEN) COMPANY LIMITED, Shenzhen (CN)

(72) Inventors: Shi Liu WANG, Guangdong (CN); San Jin YANG, Guangdong (CN); Lei DENG, Guangdong (CN); Zhou YU, Guangdong (CN)

(73) Assignee: TENCENT TECHNOLOGY (SHENZHEN) COMPANY LIMITED, Shenzhen (CN)

(21) Appl. No.: 15/982,189

(22) Filed: May 17, 2018

Related U.S. Application Data
(63) Continuation of application No. PCT/CN2017/082290, filed on Apr. 27, 2017.

(30) Foreign Application Priority Data
May 12, 2016 (CN) 201610319667.7

(51) Int. Cl. A63F 13/49; G06Q 20/12; A63F 13/335; A63F 13/352

(52) U.S. Cl. CPC A63F 13/49; A63F 13/352; A63F 13/335; G06Q 20/123

(57) ABSTRACT

A web page running method and apparatus, a terminal, and a storage medium are provided. The method includes obtaining a first operation on a first page. In response to the first operation, state information of the first page is recorded and a second page is obtained. The second page is redirected to from the first page. A second operation on the second page is obtained. The second operation is for ending the second page. In response to the second operation, the first page is redirected to from the second page according to the state information that is recorded.

### CROSS-REFERENCE TO RELATED APPLICATIONS

This application is a continuation of International Patent Application No. PCT/CN2017/082290, filed on Apr. 27, 2017, which claims priority from Chinese Patent Application No. 201610319667.7, entitled “WEB PAGE RUNNING METHOD AND APPARATUS, AND TERMINAL” filed in the Chinese Patent Office on May 12, 2016, the disclosures of which are incorporated by reference herein in their entirety.

### BACKGROUND

### 1. Field

The present disclosure relates to computer technologies, and in particular, to a web page running method and apparatus, a terminal, and a storage medium.

### 2. Description of Related Art

Users may browse web pages in a browser using a terminal. Various web pages may be opened, for example, in a new tab bar and a user may switch web pages using the tab bar. Alternatively, the terminal may open one web page in an iframe of another web page. In these two cases, opening of one web page does not affect display and running of another web page.

However, operating systems of some mobile terminals support web pages to be fully displayed on a display interface of a terminal in a full-screen manner, and browsing scenarios in a large quantity of social applications do not support multi-tab-bar browse and instead, support only single-tab-bar display. When a web page B is displayed on a tab bar, a previous web page A on the tab bar needs to be ended. In addition, most service processes do not support being performed in an iframe. That is, a service page does not support being displayed on a web page in a form of an iframe. Therefore, when the terminal supports only single-window display and does not support multi-tab-bar browse and iframe display, to open the B web page in a single window and a single tab bar, the user needs to first end the web page A. When the web page A is ended, the terminal records only general attributes (information such as a scroll position) of the web page A. State information of the web page service will be lost. In this way, when the terminal returns to the web page A from the web page B, the state of the web page A limited to an initial state of the web page A, and it is not possible to restore the state of the web page A to the state in which the web page A is ended. Consequently, the user cannot continue to view or operate the web page A in the state in which the web page A is previously ended.

### SUMMARY

It is an aspect to resolve at least one problem existing in the related art technology so as to improve user experience.

According to an aspect of one or more exemplary embodiments, there is provided a method. The method includes obtaining a first operation on a first page. In response to the first operation, state information of the first page is recorded and a second page is obtained. The second page is redirected to from the first page. A second operation on the second page is obtained. The second operation is for ending the second page. In response to the second operation, the first page is redirected to from the second page according to the state information that is recorded.

According to other aspects of one or more exemplary embodiments, there are provided an apparatus and a terminal consistent with the method.

### BRIEF DESCRIPTION OF THE DRAWINGS

Exemplary embodiments will be described below with reference to the accompanying drawings, in which:

FIG. 1 is a schematic diagram of a web page running process according to an exemplary embodiment;

FIGS. 2A-2C are schematic diagrams of a process of implementing a web page running method according to exemplary embodiments;

FIG. 3 is a schematic flowchart of triggering a login service on a web game page and then returning to the web game page according to an exemplary embodiment;

FIG. 4 is a schematic flowchart of implementing triggering a login service on a web game page and then returning to the web game page according to an exemplary embodiment;

FIG. 5 is a schematic structural diagram of a system for implementing a web game page running method according to an exemplary embodiment;

FIG. 6 is a schematic flowchart of triggering a service on a web game page and then returning to the web game page according to an exemplary embodiment;

FIG. 7A is a schematic flowchart of implementing triggering a service on a web game page and then returning to the web game page according to an exemplary embodiment;

FIG. 7B is a schematic structural diagram of a system for implementing a web game page running method according to an exemplary embodiment;

FIG. 8 is a schematic flowchart of triggering other services on a notification bar during game playing on a web game page and then returning to the web game page according to an exemplary embodiment;

FIG. 9 is a schematic structural diagram of composition of a web page running apparatus according to an exemplary embodiment;

FIG. 10A is a schematic structural diagram of configuration of hardware of a terminal according to an exemplary embodiment; and

FIG. 10B is a schematic structural diagram of hardware of a terminal according to an exemplary embodiment.

### DETAILED DESCRIPTION

In a terminal that supports multi-tab-bar browse, in a process of browsing a web page A by using a browser on a terminal by a user, when the user views other content by opening a web page B by using a link on the web page A, the user may open the web page B on a new tab bar by popping up the new tab bar. In this case, the web page A and the web page B are synchronously displayed on different tab bars of the browser. The user may select to browse the web page A or the web page B by means of an operation of switching tab bars. Alternatively, in a terminal that supports iframe display, the terminal may open the web page B in an iframe of the web page A, and the web page B is displayed on the web page A as an iframe bar. The user may return to the web page A by closing the iframe bar of the web page B. In the foregoing two cases, opening the web page B by the terminal does not affect display and running of the web page A. The user may arbitrarily switch between the web page A and the web page B. After the user returns to the web page A, the web page A is still in a state in which the user leaves the web page A.

However, as discussed above in the background, in terminals, operating systems, and applications that do not support multi-tab-bar browse and instead, support only single-tab-bar display such that web pages must be fully displayed on a display interface of a terminal in a full-screen manner, several technical problems arise. When a web page B is displayed on a tab bar, a previous web page A on the tab bar needs to be ended. In addition, most service processes do not support being performed in an iframe. That is, a service page does not support being displayed on a web page in a form of an iframe. Therefore, when the terminal supports only single-window display and does not support multi-tab-bar browse and iframe display, to open the B web page in a single window and a single tab bar, the user needs to first end the web page A. When the web page A is ended, the terminal records only general attributes (information such as a scroll position) of the web page A. State information of the web page service will be lost. In this way, when the terminal returns to the web page A from the web page B, the state of the web page A limited to an initial state of the web page A, and it is not possible to restore the state of the web page A to the state in which the web page A is ended. Consequently, the user cannot continue to view or operate the web page A in the state in which the web page A is previously ended.

The exemplary embodiments provide a web page running method and apparatus, a terminal, and a storage medium. The terminal obtains a first operation of a user on a first page; records state information of the first page in response to the first operation and obtains a second page; ends the first page, and redirects to the second page from the first page; obtains a second operation of the user on the second page, the second operation being used to end the second page; and redirects to the first page from the second page according to the state information of the first page in response to the second operation. In this way, the first page to which the terminal redirects is still in the state in which the first page is previously ended, and the user may continue to view or operate the first page in the state, thereby resolving the technical problems described above and improving user experience.

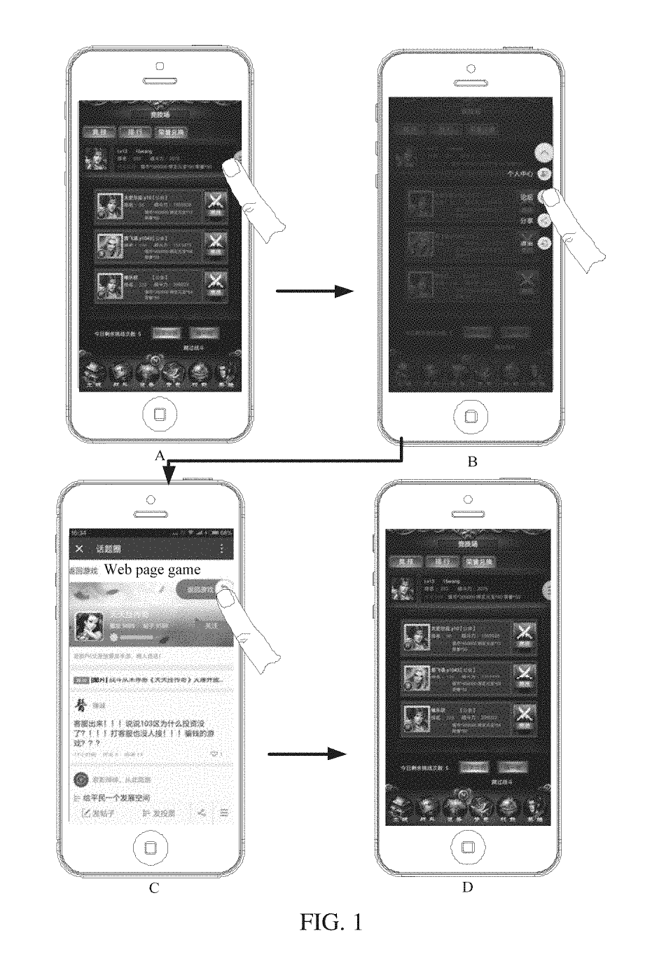

In an exemplary embodiment, as shown in FIG. 1, according to an operation of a user on a web game page shown in A of FIG. 1, a terminal displays the web game page, and then according to an operation of the user on the web game page shown in B of FIG. 1, the terminal redirects to a forum page shown in C of FIG. 1 from the web game page shown in B of FIG. 1. Then, upon tapping on a short-cut menu “return to the game” to return to the web game page in C of FIG. 1, the state of the web game page displayed on the terminal is shown in D of FIG. 1, and is a state in which the web game page is previously ended, i.e., the state shown in A of FIG. 1.

Technical solutions of the present disclosure are further described in detail below with reference to the accompanying drawings and specific exemplary embodiments.

To resolve the problem existing in the background, exemplary embodiments provide a web page running method, applied to a terminal. The function implemented by the web page running method may be implemented by invoking a program code by a processor in the terminal. The program code may be stored in a computer storage medium. In view of this, the terminal includes at least a processor and a storage medium.

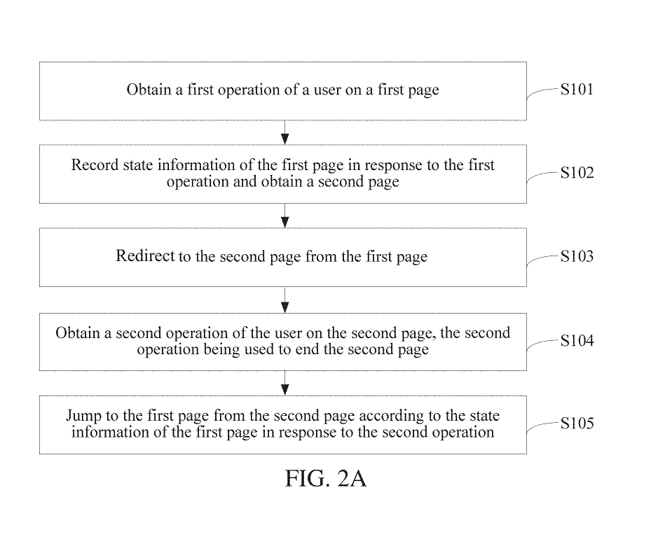

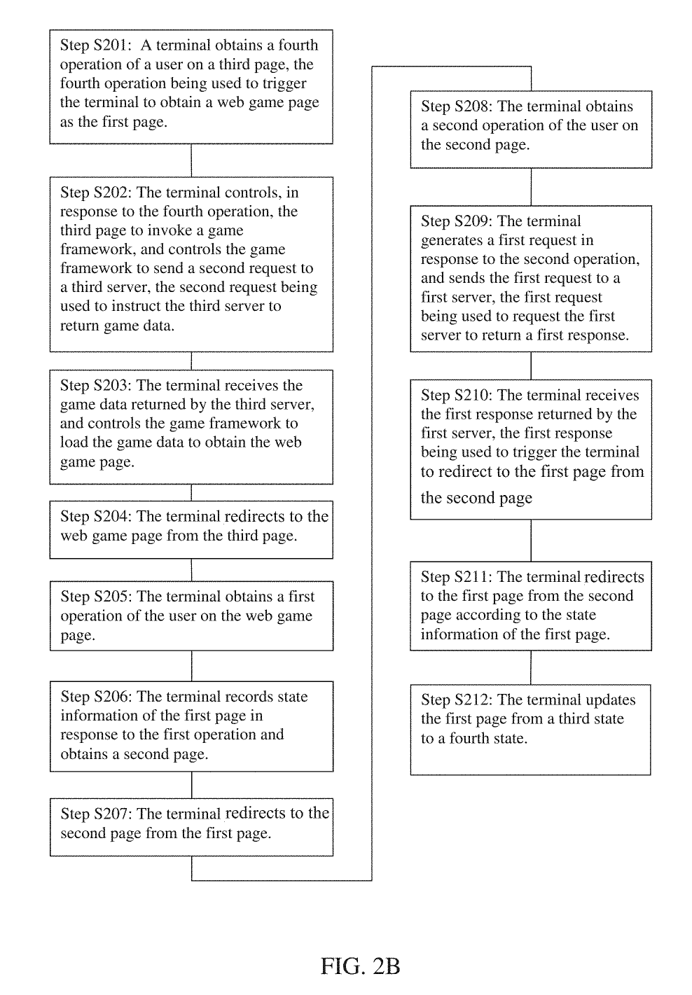

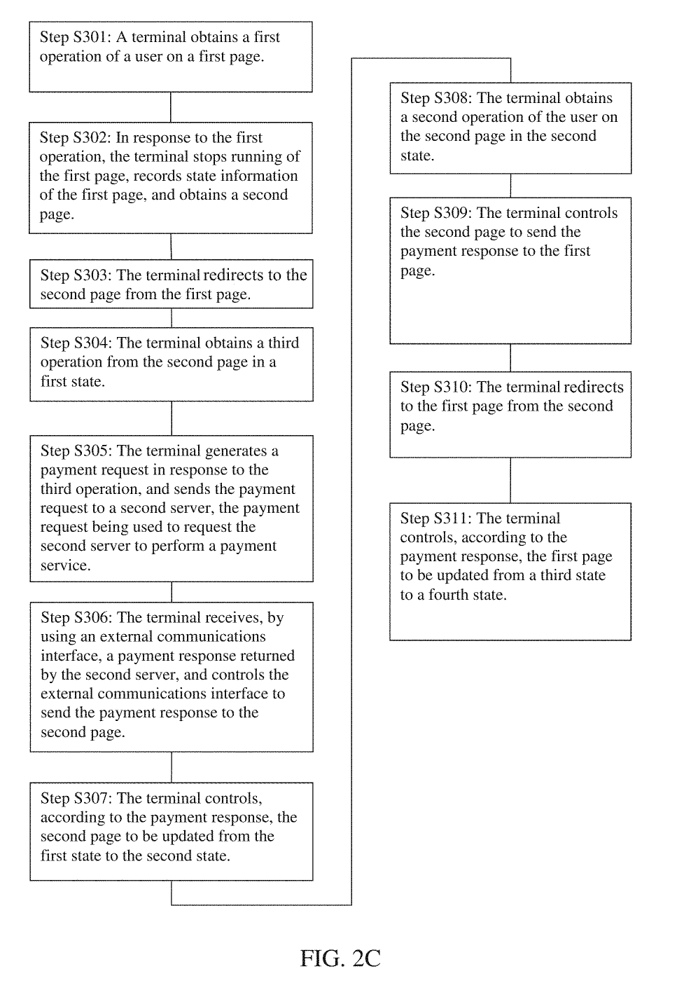

FIG. 2 is a schematic diagram of a process of implementing a web page running method according to an exemplary embodiment. As shown in FIG. 2, the method includes:

Step S101: Obtain a first operation of a user on a first page.

In this exemplary embodiment, the first page and a second page in the following exemplary embodiments may both be web pages. Resources loaded on the first page include multimedia resources and/or game resources. The web pages may use web pages of various versions, for example, an H5 (the Hypertext Markup Language (HTML) standard after fifth major revision of the HTML) page.

For example, the first page may be a web game page. As shown in FIG. 1, after the terminal loads and displays the first page, that is, the web game page, a user may perform, on a terminal screen by using a finger or an electroprobe, a touch operation on the displayed web game page.

The first operation may be an operation that the user requests the terminal to load a page outside a web game. The first operation may include an operation of tapping an external link and an operation of tapping to perform a service (the service cannot be performed on the web game page and needs a specific service page). In the example shown in FIG. 1, when performing a particular game level on the web game page, the user performs the first operation on the web game page.

In the process of running the game on the web game page by the user, the web game page has two types of external new page: an external link and a service process. In this exemplary embodiment, for example, the new page corresponding to the external link may be a forum page. As shown in A of FIG. 1, after the user taps a menu virtual key in the web game page, as shown in B of FIG. 1, the terminal displays a menu short-cut menu including a hover bar such as “forum” on the web game page. After the user taps the hover bar “forum”, the terminal obtains the operation that the user taps the hover bar “forum”, that is, obtains the first operation of the user on the web game page.

Step S102: Record state information of the first page in response to the first operation and obtain a second page.

Continuing the foregoing example, after obtaining the operation that the user taps the hover bar “forum”, the terminal knows that the user is about to enter the second page, that is, the forum page. In this case, the terminal records state information of the first page. The state information may be, for example, game progress information like a game level currently located on the web page game and/or the number of remaining challenge times of the user today, and/or page progress information like content, displayed on the current display interface by the terminal, of the web game page, etc. Thus, the terminal may completely restore the web game page shown in B of FIG. 1 according to the state information. The terminal obtains the forum page.

The process in which the terminal obtains the forum page may be obtaining, by the terminal, an external link corresponding to the forum page according to the obtained first operation. The external link may be in a form of a uniform resource locator (URL). The terminal sends a request to a forum server according to the URL. The forum server returns data of the forum page to the terminal. After obtaining the data of the forum page, the terminal generates the forum page on such basis.

Step S103: Redirect to the second page from the first page.

Continuing the foregoing example, after obtaining the second page, that is, the forum page, as shown in FIG. 1, the terminal redirects to the forum page shown in C of FIG. 1 from the web game page shown in B of FIG. 1.

When redirecting to the second page from the first page, the first page may be displayed as the short-cut menu “return to the game” on the second page in an animation manner. In this way, the user may sense that the short-cut menu “return to the game” may be used to return to the game when browsing the second page. In addition, a hover menu on the web game page and the short-cut menu “return to the game” hiding the web game page on the first page are kept at a same position of the display interface, thereby facilitating user operation and improving user experience.

Step S104: Obtain a second operation of the user on the second page, the second operation being used to end the second page.

The user may perform a slide operation on the forum page to view various information in a forum. After viewing a strategy guide of the game level, the user may perform a second operation on the second page. The second operation is used to end the second page, and indicates that the user is about to leave the second page. The second operation may include a return operation and/or an end operation. For example, as shown in C of FIG. 1, tapping the short-cut menu “return to the game” on the second page by the user may be the second operation (the return operation) of the user, or tapping a virtual close key “x” on the second page by the user may be the second operation (the end operation) of the user.

Step S105: Redirect to the first page from the second page according to the state information of the first page in response to the second operation.

After obtaining the second operation, the terminal ends the second page in response to the second operation, and restores the first page according to the state information of the first page. That is, the first page is opened again in a state specified by the state information. The terminal controls the page on the display interface to redirect to the first page shown in D of FIG. 1 from the forum page shown in C of FIG. 1.

In this exemplary embodiment, the web page running method may be run in various browsers, and the user may freely switch between browsing the forum page and the game, and does not lose the progress of the game, so that the entire game experience is smoother, thereby improving user experience.

In this exemplary embodiment, when a terminal ends the first page, and redirects to displaying of a second page from displaying of the first page, the terminal records current state information of the first page. In this way, when returning to the first page from the second page, the terminal restores the first page according to the state information of the first page, so that the first page displayed during returning of the first page is restored to the state in which the first page is ended. In this way, a user may continue to view or operate the first page in the state in which the first page is previously ended, thereby improving user experience.

Based on the foregoing exemplary embodiment, an exemplary embodiment provides a web page running method, applied to a terminal. The terminal supports only single-window display and a page of the single-window display is fully displayed on a display interface of the terminal in a full-screen manner. The function implemented by the web page running method may be implemented by invoking a program code by a processor in the terminal. The program code may be stored in a computer storage medium. In view of this, the terminal includes at least a processor and a storage medium. The method is shown n FIG. 2B. It should be noted that Steps S205, S206, S207, S208, and S211 may correspond to Steps S101-S105 in FIG. 2A. As shown in FIG. 2B, the method includes:

Step S201: A terminal obtains a fourth operation of a user on a third page, the fourth operation being used to trigger the terminal to obtain a web game page as the first page.

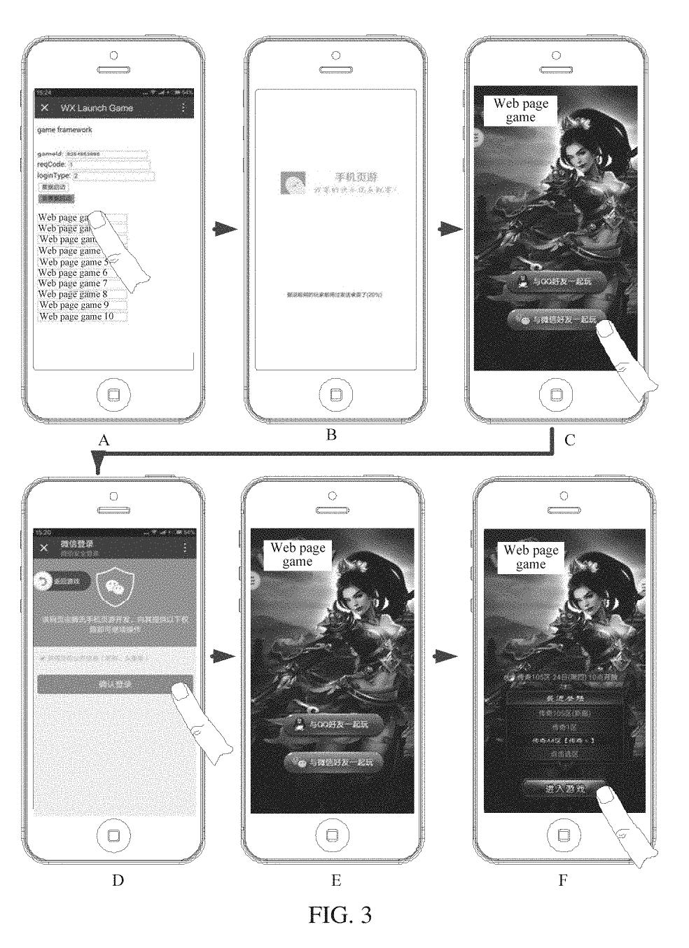

For example, as shown in A of FIG. 3, after a WebView control of the terminal loads and displays a third page, that is, an official account page of a WeChat game, a user may perform, on a terminal screen by using a finger, a touch operation on the displayed official account page. The user performs a fourth operation on the official account page: for example, as shown in A of FIG. 3, an operation that the user taps “web page game 1” by using a finger, to trigger the terminal to start a process of obtaining a web game page corresponding to the “web page game 1”.

Step S202: The terminal controls, in response to the fourth operation, the third page to invoke a game framework, and controls the game framework to send a second request to a third server, the second request being used to instruct the third server to return game data.

The WebView control of the terminal obtains a game ID corresponding to the “web page game 1” in response to the fourth operation, invokes a game framework by using a Java Script Application Programming Interface (JSAPI), controls the game framework to generate a second request according to the game ID, and controls the game framework to send the second request to a third server, that is, a game server. The second request may be used to instruct the third server to return game data corresponding to the “web page game 1”.

Step S203: The terminal receives the game data returned by the third server, and controls the game framework to load the game data to obtain the web game page.

After receiving the second request, the third server returns the game data corresponding to the “web page game 1” to the terminal. After receiving the game data, the terminal sends the game data to the game framework, and controls the game framework to load the game data, to obtain a web game page corresponding to the “web page game 1”.

In step S202 and step S203, the display interface of the terminal may display a transition page shown in B of FIG. 3.

Step S204: The terminal redirects to the web game page from the third page.

After obtaining the web game page corresponding to the “web page game 1”, the terminal redirects to the web game page from the third page and starts to run the “web page game 1”. In this case, as shown in C of FIG. 3, the web game page displayed on the display interface of the terminal is in an initial state, that is, a to-be-logged state.

Step S205: The terminal obtains a first operation of the user on the web game page.

When the terminal redirects to the web game page from the third page, the web game page is in the to-be-logged state, and the user performs a login service. As shown in C of FIG. 3, after the user taps “play with WeChat friends” in the web game page, the terminal obtains the tapping operation of the user, that is, obtains the first operation of the user on the web game page.

Step S206: The terminal records state information of the first page in response to the first operation and obtains a second page.

Continuing the foregoing example, after obtaining the operation that the user taps the virtual key “play with WeChat friends”, the terminal knows that the user is about to enter a second page, that is, a login page. In this case, the game framework of the terminal records state information of the web game page, for example, records that the web game page is in the to-be-logged state. The game framework of the terminal may completely restore the web game page in the to-be-logged state shown in C of FIG. 3 according to the state information. Moreover, the game framework of the terminal invokes a login interface, and notifies, by using the login interface, the WebView control of loading and displaying the login page.

Step S207: The terminal redirects to the second page from the first page.

After the WebView control of the terminal obtains the second page, that is, the login page, as shown in FIG. 3, the terminal redirects to the login page shown in D of FIG. 3 from the web game page shown in C of FIG. 3.

Step S208: The terminal obtains a second operation of the user on the second page.

As shown in D of FIG. 3, a second operation of the user on the second page, that is, the login page may be an operation that the user taps the short-cut menu “return to the game” on the login page, or may be an operation that the user taps a virtual key “confirm login” on the login page.

When the second operation is the operation that the user taps the short-cut menu “return to the game” on the login page, the terminal performs only step S211 in response to the second operation. When the second operation is the operation that the user taps the virtual key “confirm login” on the login page, the terminal performs step S209 to step S212 in response to the second operation.

Step S209: The terminal generates a first request in response to the second operation, and sends the first request to a first server, the first request being used to request the first server to return a first response.

The terminal obtains WeChat account information in response to the operation that the user taps the virtual key “confirm login”, and generates a first request on such basis. The first request includes the WeChat account information. The terminal sends the first request to a first server, that is, a WeChat server. The first request is used to request the WeChat server to authorize the WeChat account information for use in this game.

Step S210: The terminal receives the first response returned by the first server, the first response being used to trigger the terminal to redirect to the first page from the second page.

After receiving the first request and confirms that the user authorizes to use the WeChat account information to log in to this game, the WeChat server returns, to the terminal, a first response indicating that authorization of the WeChat account information succeeds. The first response includes the WeChat account information. After receiving the first response, the terminal confirms that the user authorizes to use the WeChat account information to log in to this game. In this case, starting to redirect to the first page from the second page is triggered.

Step S211: The terminal redirects to the first page from the second page according to the state information of the first page.

After receiving the first response by using an external communications interface, the terminal sends the first response to the WebView control. After obtaining the first response, the WebView control directly ends the second page, and forwards the first response to the game framework by using the JSAPI. After obtaining the first response, the game framework of the terminal restores the web game page shown in B of FIG. 3 according to the state information of the first page, and redirects to the web game page shown in E of FIG. 3 from the login page shown in D of FIG. 3. As shown in FIG. 3, the web game page shown in E of FIG. 3 and the web game page shown in B of FIG. 3 are in a same state.

Step S212: The terminal updates the first page from a third state to a fourth state.

The first response includes the WeChat account information authorized for login and a game ID for login. After receiving the first response, the game framework stores the identity information: the WeChat account information and the game ID, as a login bill, into a memory of the terminal by using a game client, then performs processing such as encryption on the login bill, and then sends the login bill to the game server. After performing decryption to obtain the login bill, the game server obtains login data corresponding to the login bill. Then, the game server calls back the game, and sends the login data corresponding to the login bill to the terminal. The terminal sends the login data to the game framework, and controls the game framework to update the first page from the third state to the fourth state. The third state may be a state in which the first page is loaded with the state information, that is, the state shown in B and E of FIG. 3, and the fourth state may be a state after the login data is loaded to the web game page, that is, the state shown in F of FIG. 3. The user taps a virtual key “enter the game” in F of FIG. 3 and may play the game.

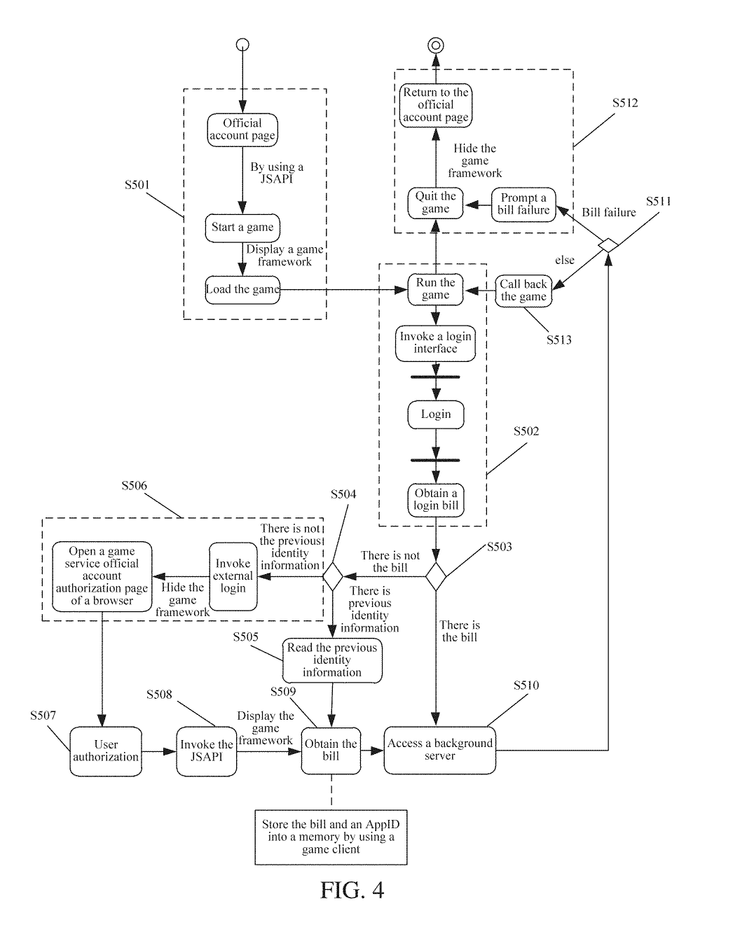

By using the foregoing login service as an example, the process of implementing the method of this exemplary embodiment is described, as shown in FIG. 4.

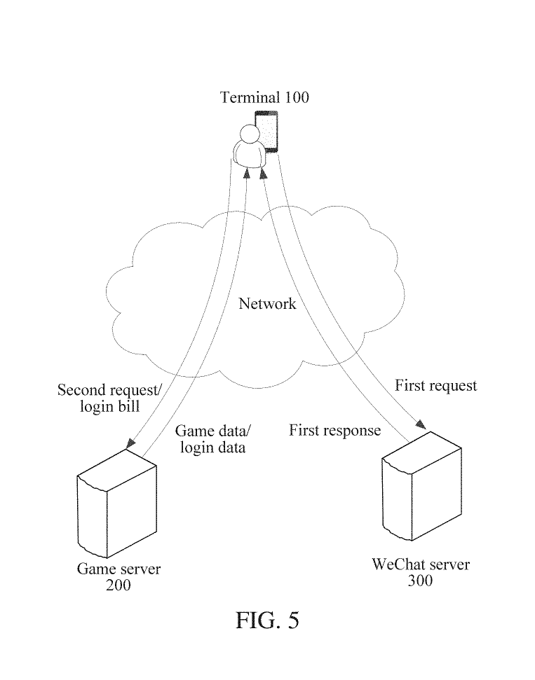

Step S501: After loading and displaying an official account page of a WeChat game, a WebView control of a terminal obtains a fourth operation of a user on the official account page; in this case, the WebView control of the terminal obtains a game ID corresponding to the fourth operation in response to the fourth operation, and controls the WebView control to invoke a game framework by using a JSAPI, sends the game ID to the game framework, and control the game framework to start the game; the terminal may display, in a form of a transition page, a process of starting the game by the game framework; after receiving the game ID, the game framework generates a second request according to the game ID; as shown in FIG. 5, the terminal 100 controls the game framework to send a second request to a third server, that is, a game server 200; after receiving the second request, the game server 200 returns corresponding game data to the terminal 100; the terminal receives the game data and sends the game data to the game framework to control the game framework to load data of the game; after the game framework loads the game data to form a web game page, the terminal redirects to the web game page from the official account page; the terminal displays the web game page; in this case, the web game page is located in a to-be-logged state in C of FIG. 3.

Step S502: The terminal starts to run the game on the web game page; the game is in a to-be-logged state; the user triggers a login service on the web game page; as shown in C of FIG. 3, the user performs a first operation (that is, tapping “play with WeChat friends”) on the web game page in the to-be-logged state; the terminal obtains the first operation of the user on the web game page to trigger the login service; in this case, the terminal controls the game framework to invoke a login interface to start the login service; the game framework of the terminal obtains a login bill.

Step S503: The terminal determines whether a login bill of a previous user is recorded in the game framework.

Step S510: If the login bill of the previous user is recorded in the game framework, the terminal directly accesses a background server, that is, the game server, and sends the login bill to the game server; that is, the terminal directly controls the game framework to send the login bill to the game server.

Step S504: If the login bill of the previous user is not recorded in the game framework, determine whether previous identity information may be read; if an operation of authorizing WeChat to log in to the game is performed before the web game page is opened this time, the terminal may store the previous identity information: the login bill and an application (APP) ID of the game into the memory when the user authorizes login; the game framework may read the previous identity information; if the operation of authorizing WeChat to log in to the game is not performed before the web game page is opened this time, the game framework cannot read the previous identity information.

Step S505: When there is the previous identity information, the terminal controls the game framework to read the previous identity information, and obtains the login bill from the previous identity information; then the terminal controls the game framework to send the login bill to the game server; the foregoing processes are all completed by the terminal controlling the game framework; reference may be made to the existing login process for the process; the terminal may always display the web game page on the display interface without page redirecting.

Step S506: When there is not the previous identity information, the terminal invokes external login; the WebView control of the terminal invokes the game framework by using the JSAPI, that is, hides the game framework, and ends the current web game page, records the state information of the first page, and loads a game service official account authorization page of a browser; the terminal redirects to the game service official account authorization page, that is, the login page, shown in D of FIG. 3 from the web game page shown in C of FIG. 3.

Step S507: The user performs authorization; that is, the user taps the virtual key “confirm login” on the login page shown in D of FIG. 3 for authorization; in this case, the terminal obtains the second operation of the user on the login page, and controls the WebView control to generate a first request in response to the operation that the user taps the virtual key “confirm login”; the first request is used to request the first server, that is, the WeChat server to authorize this WeChat account for use in this game; as shown in FIG. 5, the terminal 100 sends the first request to the WeChat server 300; after the WeChat server 300 receives the first request and confirms that the user authorizes to use to the WeChat account information to log in to this game, the WeChat server 300 returns, to the terminal, a first response indicating that authorization succeeds.

Step S508: After receiving the first response by using the external communications interface, the terminal 100 sends the first response to the WebView control; after obtaining the first response, the WebView control directly ends the second page, and forwards the first response to the game framework by using the JSAPI; after the game framework of the terminal obtains the first response, the first response triggers the game framework to restore the web game page shown in B of FIG. 3 according to the state information of the first page, and the terminal redirects to the web game page shown in E of FIG. 3 from the login page shown in D of FIG. 3.

Step S509: The game framework obtains the login bill; the terminal may obtain the login bill by reading the previous identity information in step S505 or control the game framework to obtain the login bill from the received first response in step S508; in this case, the terminal stores the identity information: the WeChat account information and the game ID, as the login bill, into the memory by using the game client.

Step S510: The terminal controls the game framework to perform processing such as encryption on the login bill, and then sends the login bill to the game server.

Step S511: After obtaining the login bill, the game server may first perform validity check on the login bill.

Step S512: When it is checked that the authorized bill is invalid, as shown in FIG. 5, the game server 200 sends a game quit notification to the terminal; after receiving the game quit notification, the terminal 100 controls the game framework to quit the game, closes the web game page, and returns to the official account page.

Step S513: When the login bill is valid, the game server 200 calls back the game, and sends the login data corresponding to the login bill to the terminal; the terminal runs the game according to the login data, and controls, according to the login data, the web game page to run from the state shown in B of FIG. 3 to the state shown in E of FIG. 3.

Services used in the method of this exemplary embodiment may also be services such as sharing, ballot rigging, and pulling friends in addition to the login service. Details are not described herein again.

The game framework on the terminal controls running of the web game page to be independent of the page controlled and displayed by the WebView control. The user may freely switch between the page controlled and displayed by the WebView control and the web game page controlled by the game framework, and does not lose the progress of the game on the web game page, so that the entire game experience is smoother. The method of this exemplary embodiment is applicable to various browsers.

In this exemplary embodiment, when a terminal ends the first page to enter a service process, and redirects to displaying of a second page from displaying of the first page, the terminal records current state information of the first page. In this way, when returning to the first page from the second page, the terminal restores the first page according to the state information of the first page, so that the first page displayed during returning is restored to the state in which the first page is ended. In this way, a user may continue to view or operate the first page in the state in which the first page is previously ended, thereby improving user experience.

Based on the foregoing exemplary embodiments, an exemplary embodiment provides a web page running method, applied to a terminal. The terminal supports only single-window display and a page of the single-window display is fully displayed on a display interface of the terminal in a full-screen manner. The function implemented by the web page running method may be implemented by invoking a program code by a processor in the terminal. The program code may be stored in a computer storage medium. In view of this, the terminal includes at least a processor and a storage medium. As shown in FIG. 2C, the method includes:

Step S301: A terminal obtains a first operation of a user on a first page.

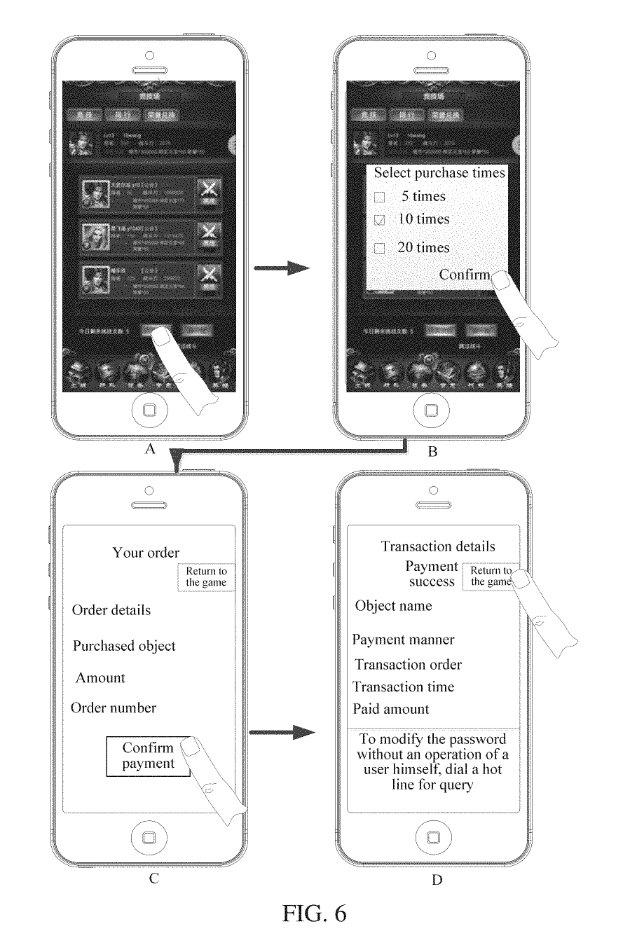

After a game framework of the terminal loads and displays the first page, that is for example, a web game page, the user may perform, on a terminal screen by using a finger or an electroprobe, a touch operation on the displayed web game page. As shown in A of FIG. 6, after the user taps a virtual key “purchase times”, the game framework pops up an option box “select purchase times” on the web game page in response to the operation, so that the user may place an order. After the user selects purchase times “10 times” in the option box “select purchase times” and taps confirmation, the terminal obtains the first operation of the user on the first page.

Step S302: In response to the first operation, the terminal stops running of the first page, records state information of the first page, and obtains a second page.

After the game framework of the terminal obtains the first operation that the user taps the virtual key “confirm purchase”, the terminal starts a payment service in response to the first operation. In this case, the terminal stops running of the first page, and records state information of the first page, such as game progress information like a game level currently located on the web page game, the number of remaining challenge times of the user today, and remaining gold coins, and page progress information like content currently displayed in the web game page by the terminal. The terminal may completely restore the web game page shown in B of FIG. 6 according to the state information. Moreover, the terminal obtains the second page, that is, a payment page.

Step S303: The terminal redirects to the second page from the first page.

After obtaining the second page, that is, the payment page, as shown in FIG. 6, the terminal redirects to the payment page shown in C of FIG. 6 from the web game page shown in A of FIG. 6.

Step S304: The terminal obtains a third operation from the second page in a first state.

The first state is a state in which the second page is loaded with a payment information input request, and the second page in the first state is shown in C of FIG. 6. The third operation may be a payment information confirmation input operation.

As shown in C of FIG. 6, the user may also perform an operation of tapping a short-cut menu “return to the game”. In this case, after obtaining the operation from the second page in the first state, in response to the operation, the terminal may directly redirect to the first page from the second page according to the state information of the first page.

Step S305: The terminal generates a payment request in response to the third operation, and sends the payment request to a second server, the payment request being used to request the second server to perform a payment service.

After obtaining the third operation, in response to the third operation, a WebView control of the terminal generates a payment request according to payment information confirmed by the user and a login bill of the user, and sends the payment request to the second server, that is for example, a payment server. After receiving the payment request, the payment server performs a payment service according to user information and payment information in the payment request, and returns a payment response to the terminal after the payment service is completed.

Step S306: The terminal receives, by using an external communications interface, a payment response returned by the second server, and controls the external communications interface to send the payment response to the second page.

The payment response includes a payment result of completing the payment service by the payment server. The terminal receives the payment response by using the external communications interface, and controls the external communications interface to send the payment response to the WebView control.

Step S307: The terminal controls, according to the payment response, the second page to be updated from the first state to the second state.

After obtaining the payment response, the WebView control loads the payment response to the second page, so that the second page is updated from the first state to the second state. The second state is a state in which the second page is loaded with the payment result. The second page in the second state is shown in D of FIG. 6.

Step S308: The terminal obtains a second operation of the user on the second page in the second state.

The second operation may be a return operation of tapping “return to the game” on the second page by the user, or an end operation of tapping “payment succeeds” on the second page by the user.

Step S309: The terminal controls the second page to send the payment response to the first page.

The WebView control of the terminal sends the payment response to the game framework by using a JSAPI. The WebView control may correspond to the second page. The game framework may correspond to the first page.

The terminal may skip step S307 and S308. After obtaining the payment response, the terminal directly controls the WebView control to send the payment response to the game framework by using the JSAPI.

Step S310: The terminal redirects to the first page from the second page.

After obtaining the second operation, the WebView control of the terminal ends the second page in response to the second operation. After receiving the payment response, the game framework restores the first page according to the state information of the first page, and redirects to the first page shown in B of FIG. 6 from the payment page shown in D of FIG. 6.

Step S311: The terminal controls, according to the payment response, the first page to be updated from a third state to a fourth state.

The terminal controls the game framework to load the payment response to the first page, so that the first page is updated from the third state to the fourth state. The third state may be a state in which the first page is loaded with the state information, and the fourth state may be a state in which the first page in the third state is loaded with the payment result corresponding to the payment service. For example, continuing the foregoing exemplary embodiment, the number of remaining challenge times of the user today in the third state is 5, and the obtained payment response is a response to successful purchase of 10 challenge times. Then, the number of remaining challenge times of the user today in the fourth state is 15.

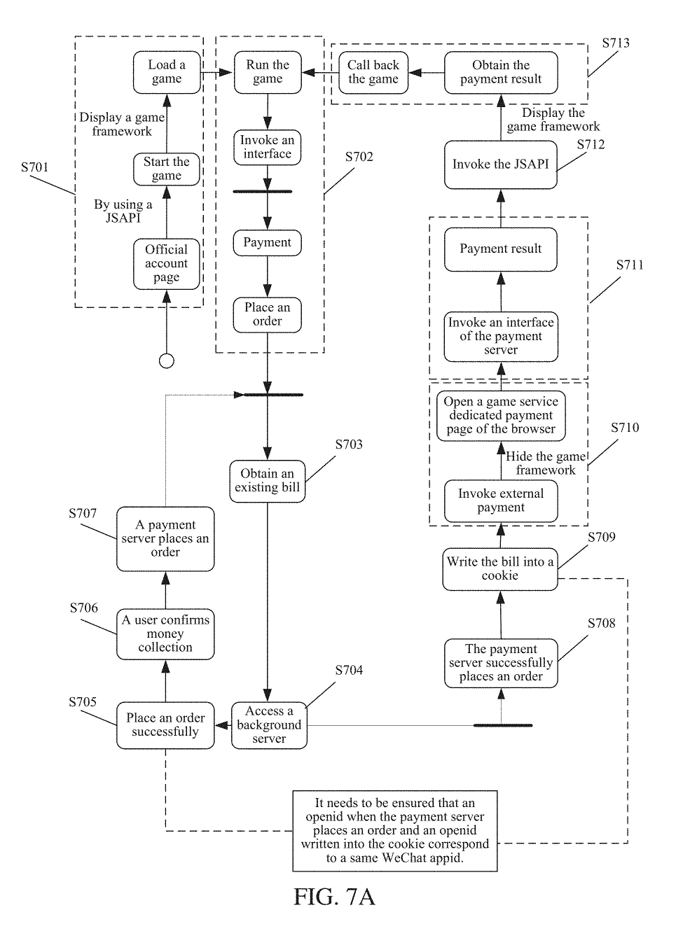

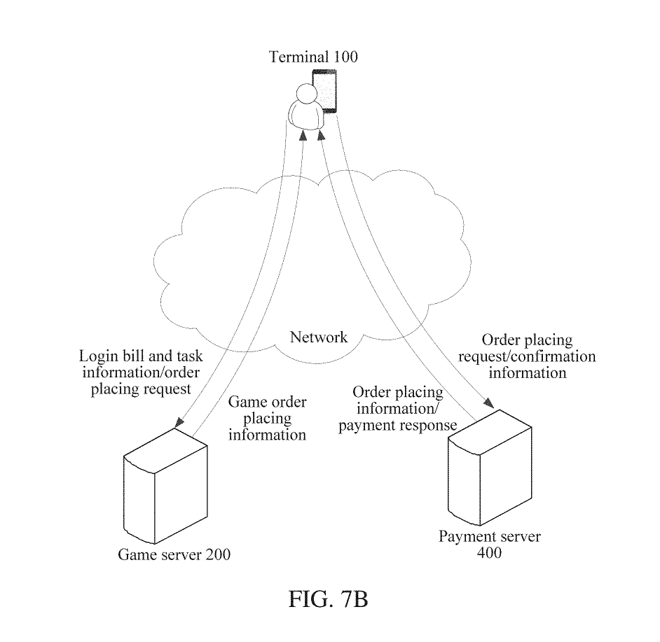

The process of the method of this exemplary embodiment may be shown in FIG. 7A.

Step S701: A terminal displays an official account page of a WeChat game, and obtains a fourth operation of a user on the official account page; the terminal obtains a game ID corresponding to the fourth operation in response to the fourth operation, and controls the official account page to invoke a game framework by using a JSAPI, controls the game framework to start the game, and controls the game framework to generate a second request according to the game ID; the terminal controls the game framework to send the second request to a third server, that is for example, a game server; after receiving the second request, the game server returns corresponding game data to the terminal; after receiving the game data, the terminal sends the game data to the game framework, and controls the game framework to load data of the game; the process of controlling, by the terminal, the game framework to load the game may be displayed in a form of a transition page; after the game framework loads the game data to form a web game page, the terminal displays the web game page; in this case, the web game page is in a to-be-logged state, and after performing a login process to log in to the game, the user may perform a game task.

Step S702: After the user logs in to the game, the user starts to run the game; if the user performs a payment service in the process of running the game to perform the game task, as shown in A of FIG. 6, the user taps “purchase times” on the web game page to trigger the payment service; in this case, the terminal controls the game framework to invoke a payment interface to start the payment service; the terminal controls the game framework to invoke the payment interface to start a game order placing task in response to the first operation, to obtain task information.

Step S703: The terminal obtains an existing bill; in this case, the obtained existing bill is a login bill; because the user has logged in to the game, the terminal may obtain the login bill from the memory.

Step S704: Access a background server, that is, as shown in FIG. 7B, the terminal 100 controls the game framework to invoke the payment interface to send the login bill and task information to the background server, that is, the game server 200.

Step S705: The game server successfully places an order; the game server 200 obtains user information according to the login bill, and obtains game order placing information such as how much money is needed for the user to purchase XX challenge times by placing an order; the game server 200 sends the game order placing information to the terminal 100; the terminal 100 controls the game framework to invoke the payment interface to display, on the web game page, an order placing option box, that is, the option box “select purchase times” shown in B of FIG. 6, corresponding to the game order placing information; in this case, the game server successfully places an order.

Step S706: the user confirms payment; the user selects a to-be-purchased object and taps a virtual key “confirm purchase” on an order placing short-cut menu; that is for example, the user confirms payment. The operation that the user taps the virtual key “confirm purchase” on the order placing short-cut menu is the first operation of the user on the web game page. In this case, the terminal obtains the first operation of the user on the web game page, and in response to the first operation, generates an order placing request of confirming the game order placing information by the user. The terminal controls the game framework to send the order placing request to the payment server.

Step S707: The payment server places an order, performs an order placing task according to the order placing request, and generates order placing information such as an order placing sequence number.

Step S708: The payment server successfully places an order, that is, the payment server 400 sends the order placing information to the terminal.

Step S709: The terminal stores the login bill corresponding to the order placing information into a cookie of the terminal; it should be noted that the openid when the payment server places an order and the openid written by the terminal into the cookie correspond to a same WeChat appid, that is for example, a same user is ensured.

Step S710: The game framework of the terminal invokes an external payment interface to send the order placing information (the order placing information includes, by using a url parameter, a parameter needed by the payment service and a unique identification number requested by the payment service) to the WebView control; the WebView control generates the payment page on such basis, and the terminal opens a game service dedicated payment page of the browser, that is for example, the payment page, and the terminal redirects to the payment page shown in C of FIG. 6 from the web game page.

Step S711: The user may perform a payment confirmation operation on the payment page; the terminal obtains the payment confirmation operation from the payment page shown in C of FIG. 6; then, as shown in FIG. 7B, the terminal controls the WebView control to invoke an interface of the payment server, and sends the confirmation information to the payment server 400; the payment server 400 performs a payment task; after completing the payment task, the payment server 400 includes the payment result into a payment response and sends same to the terminal 100; the terminal receives, by using the external communications interface, the payment response returned by the payment server 400, and controls the external communications interface to send the payment response to the WebView control; the terminal controls the WebView control to control, according to the payment response, the second page to be updated from the first state to the second state, and the payment page in the second state is shown in D of FIG. 6.

Step S712: After the return operation that the user taps “return to the game” on the second page or the end operation that the user taps “payment succeeds” on the second page, the terminal obtains the second operation; when the WebView control of the terminal obtains the second operation of the user on the second page in the second state, the WebView control ends the second page in response to the second operation; moreover, the game framework is invoked by using the JSAPI to restore the first page; the terminal redirects to the first page from the second page.

Step S713: The terminal controls the WebView control to send the payment response to the game framework; in this way, the terminal may control the game framework to update, according to the payment response, the first page from the third state to the fourth state; the process thereof may be: the terminal controls the game framework to send the payment response to the game server; the game server updates game data of the response, that is, the payment result, according to the payment response, and then calls back the game, and sends updated game data to the terminal; the terminal controls the game framework to run the game, loads the updated game data, and updates the first page from the third state to the fourth state.

The payment response includes a unique identification code of the payment service. Therefore, the game framework corresponds, by using a unique identification number, the payment response to the payment service recorded by the game framework, and updates, according to the unique identification code, the corresponding payment service according to the payment result corresponding to the payment response.

As may be seen from above, in the process of running the game on the web game page, when the user performs a service process (during login and payment) by using the second page, the user pauses the game, minimizes the game framework into a short-cut menu, and hangs the short-cut menu on the second page; the user may tap the short-cut menu at any time to return to the web game page; or when the payment is completed, the second page automatically redirects to the web game page and returns to the game, and the game on the web game page may keep the state before the pause.

In this exemplary embodiment, when a terminal ends the first page, and redirects to displaying of a second page from displaying of the first page, the terminal records current state information of the first page. In this way, when returning to the first page from the second page, the terminal restores the first page according to the state information of the first page, so that the first page displayed during returning may be restored to the state in which the first page is ended. In this way, a user may continue to view or operate the first page in the state in which the first page is previously ended, thereby improving user experience. In addition, in the related art technology, after completing payment, the second page does not notify the first page. The first page sends an update request to the game server to update the state only when the user performs an operation of tapping “complete payment”. However, in this exemplary embodiment, after completing payment, the second page may send the payment response to the first page without an operation of the user, so that the first page may quickly and actively send an update request to the game server, to update the state of the first page.

Based on the foregoing exemplary embodiments, an exemplary embodiment provides a web page running method, applied to a terminal. The terminal supports only single-window display and a page of the single-window display is fully displayed on a display interface of the terminal in a full-screen manner. The function implemented by the web page running method may be implemented by invoking a program code by a processor in the terminal. Certainly, the program code may be stored in a computer storage medium. In view of this, the terminal includes at least a processor and a storage medium. A method may include:

The terminal controls the first page to be fully displayed on the display interface in the full-screen manner.

The terminal obtains a fifth operation of a user on a notification bar of the terminal, where the fifth operation is an operation of entering a fourth page on which a notification message on a notification bar is located, and the fourth page is a page on a second application.

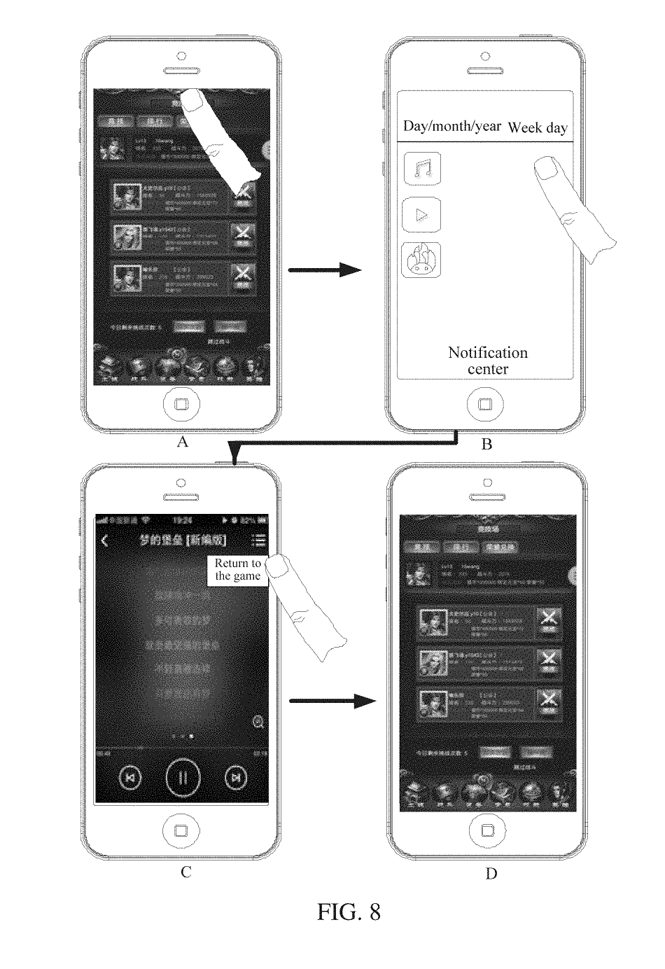

In the process of running the game on the first page, the terminal receives a notification message sent by another terminal or server to the terminal. The notification message is displayed on the notification bar of the terminal. When wanting to view the notification message, as shown in A of FIG. 8, the user performs a pull-down operation. The terminal responds to the pull-down operation. As shown in B of FIG. 8, the notification bar is displayed on the terminal. As shown in B of FIG. 8, the user may tap an option where the notification message in a music application in the notification bar is located. In this way, the terminal obtains the fifth operation.

The terminal records state data of the first page in response to the fifth operation and obtains the fourth page.

After obtaining the fifth operation, the terminal responds to the fifth operation, records state data of the first page at the moment, and obtains a music application page where the notification message in the music application is located.

The terminal controls the display interface to redirect to the fourth page from the first page.

The display interface of the terminal redirects to the music application page from the web game page.

The terminal obtains a sixth operation of the user on the display interface.

The terminal controls the fourth page to be displayed on the display interface in a full-screen manner. Moreover, a short-cut menu “return to the game” is displayed on the display interface in a pin manner. If wanting to return to the first page to continue to play the game, the user may perform the sixth operation on the display interface. As shown in C of FIG. 8, the user taps the short-cut menu “return to the game”. In this way, the terminal may obtain the sixth operation on the display interface.

The terminal controls, in response to the sixth operation and according to the state information of the first page, the display interface to redirect to the first page from the fourth page.

After obtaining the sixth operation, the terminal knows that the user wants to return to the first page to continue to play the game. In this case, the terminal responds to the sixth operation, restores the first page according to the state information of the first page, and controls the display interface to directly redirect to the first page from the fourth page. In this case, the first page displayed by the terminal is in the state shown in D of FIG. 8, which is the same as the state shown in A of FIG. 8.

The fourth page may be described by using a music application page as an example. The fourth page may alternatively be a video application page, a chat application page, a reading application page, or the like. According to this exemplary embodiment, the short-cut menu “return to the game” is displayed on the display interface of the terminal in a pin manner. No matter which application the interface displayed on the display interface belongs to, the terminal may control the display interface to redirect to the web game page from the current page provided that the user taps the short-cut menu “return to the game” on the interface. In this way, the user may read, chat, make a video call, or conduct a live broadcast as the user plays. When the user returns to the game, the user does not lose the game progress, and the user may continue the previous game.

In this exemplary embodiment, when a terminal ends the first page to enter a fourth page of another application, and redirects to displaying of the fourth page from displaying of the first page, the terminal records current state information of the first page, and displays a system-level short-cut menu “return to the game” on a display interface of the terminal in a pin manner. In this way, the terminal restores the first page according to state information of the first page, and controls the display interface to directly redirect to the restored first page from the fourth page provided that the terminal obtains a sixth operation, that is, tapping the short-cut menu “return to the game” of a user on the display interface. In this way, the first page displayed on the display interface is still in the state in which the first page is previously ended. When the user returns to the game, the user does not lose the game progress, and the user may continue the previous game, thereby improving user experience.

Based on the foregoing exemplary embodiments, an exemplary embodiment provides a web page running apparatus. Units included in the web page running apparatus and modules included in each unit may all be implemented by using a processor in the apparatus, or certainly may alternatively be implemented by using a logic circuit. In a process of this exemplary embodiment, the processor may be a central processing unit (CPU), a micro processing unit (MPU), a digital signal processor (DSP), or a field programmable gate array (FPGA).

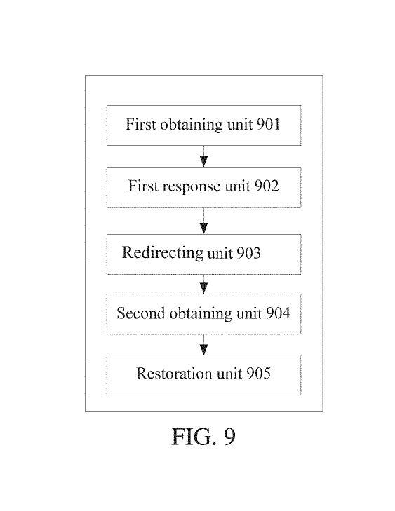

FIG. 9 is a schematic structural diagram of composition of the web page running apparatus according to this exemplary embodiment. As shown in FIG. 9, the apparatus includes a first obtaining unit 901, a first response unit 902, a redirecting unit 903, a second obtaining unit 904, and a restoration unit 905.

The first obtaining unit 901 is configured to obtain a first operation of a user on a first page, the first page being a web page, and resources loaded on the first page including multimedia resources and/or game resources.

The first response unit 902 is configured to record state information of the first page in response to the first operation and obtain a second page.

The redirecting unit 903 is configured to redirect to the second page from the first page.

The second obtaining unit 904 is configured to obtain a second operation of the user on the second page, the second operation being used to end the second page.

The restoration unit 905 is configured to redirect to the first page from the second page according to the state information of the first page in response to the second operation.

In other exemplary embodiments, the terminal supports only single-window display and a page of the single-window display is fully displayed on a display interface of the terminal in a full-screen manner. The apparatus further includes: a display unit, configured to control the first page to be fully displayed on the display interface in the full-screen manner.

In other exemplary embodiments, the restoration unit 905 is configured to generate a first request in response to the second operation, and send the first request to a first server, the first request being used to request the first server to return a first response; receive the first response returned by the first server, the first response being used to trigger the terminal to redirect to the first page from the second page; and redirect to the first page from the second page according to the state information of the first page.

In other exemplary embodiments, the apparatus further includes: a third obtaining unit, a second response unit, a receiving unit, and a first update unit.

The third obtaining unit is configured to obtain a third operation from the second page in a first state, where the first state is a state in which the second page is loaded with a payment information input request, and the third operation is a payment information confirmation input operation.

The second response unit is configured to generate a payment request in response to the third operation, and send the payment request to a second server, the payment request being used to request the second server to perform a payment service.

The receiving unit is configured to receive a payment response returned by the second server, the payment response including a payment result of completing the payment service by the server;

The first update unit is configured to control, according to the payment response, the second page to be updated from the first state to a second state, where the second state is a state in which the second page is loaded with the payment result.

The second obtaining unit is configured to obtain the second operation of the user on the second page in the second state.

In other exemplary embodiments, the apparatus further includes a second update unit.

The receiving unit is configured to receive, by using an external communications interface, the payment response returned by the second server, control the external communications interface to send the payment response to the second page, and control the second page to send the payment response to the first page.

The second update unit is configured to control the first page to be updated from a third state to a fourth state according to the payment response after the redirecting to the first page from the second page.

The third state is a state in which the first page is loaded with the state information, and the fourth state is a state in which the first page in the third state is loaded with the payment result corresponding to the payment service.

In other exemplary embodiments, the apparatus further includes: a fourth obtaining unit, a third response unit, and a second receiving unit.

The fourth obtaining unit is configured to obtain a fourth operation of the user on a third page, the fourth operation being used to trigger the terminal to obtain a web game page as the first page.

The third response unit is configured to control, in response to the fourth operation, the third page to invoke a game framework, and control the game framework to send a second request to a third server, the second request being used to instruct the third server to return game data.

The second receiving unit is configured to receive the game data returned by the third server, and control the game framework to load the game data to obtain the web game page.

The redirecting unit is configured to redirect to the web game page from the third page.

In other exemplary embodiments, the first page is a page on a first application, and the apparatus further includes a fifth obtaining unit, a fourth response unit, a sixth obtaining unit, and a fifth response unit.

The fifth obtaining unit is configured to obtain a fifth operation of the user on a notification bar of the terminal, where the fifth operation is an operation of entering a fourth page on which a notification message on the notification bar is located, and the fourth page is a page on the second application.

The fourth response unit is configured to record state data of the first page in response to the fifth operation and obtain the fourth page.

The redirecting unit is configured to control the display interface to redirect to the fourth page from the first page.

The sixth obtaining unit is configured to obtain a sixth operation of the user on the display interface.

The fifth response unit is configured to control, in response to the sixth operation and according to the state information of the first page, the display interface to redirect to the first page from the fourth page.

In other exemplary embodiments, the apparatus further includes: a stop unit, where the stop unit is configured to stop running of the first page in response to the first operation.

It should be noted that the description of the foregoing apparatus exemplary embodiments is similar to the description of the foregoing method exemplary embodiments, and the apparatus exemplary embodiments have beneficial effects similar to those of the method exemplary embodiments. For details not disclosed in the apparatus exemplary embodiments, refer to the method exemplary embodiments for understanding.

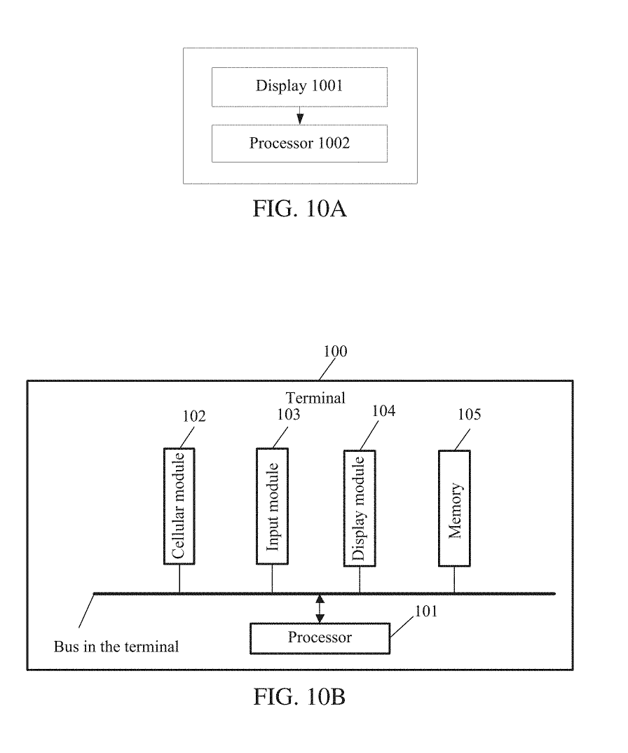

Based on the foregoing exemplary embodiments, an exemplary embodiment provides a terminal. FIG. 10A is a schematic structural diagram of composition of a terminal according to this exemplary embodiment. As shown in FIG. 10A, the terminal includes a display 1001 and a processor 1002.

The display 1001 is configured to display a first page or a second page.

The processor 1002 is configured to obtain a first operation of the user on the first page, the first page being a web page, and resources loaded on the first page including multimedia resources and/or game resources; record state information of the first page in response to the first operation and obtain the second page; control the display to redirect to displaying of the second page from displaying of the first page; obtain a second operation of the user on the second page, the second operation being used to end the second page; and redirect to the first page from the second page according to the state information of the first page in response to the second operation.

In this exemplary embodiment, the display may display information processed in the terminal. For example, when the terminal runs a game application, the display may display a user interface (UI) or a graphical user interface (GUI) related to a game. The display may be a touchscreen. That is, a display screen and a touch panel are superposed with each other in a form of layers, to form the touchscreen. In this way, the display may be used as an input apparatus and an output apparatus. The display may include at least one of a liquid crystal display (LCD), a thin film transistor LCD (TFT-LCD), an organic light emitting diode (OLED) display, a flexible display, a three-dimensional (3D) display, or the like. Some of these displays may be constructed as transparent to allow the user to view from the outside, and these displays may be referred to as transparent displays. A typical transparent display may be, for example, a transparent organic light emitting diode (TOLED) display, or the like. In other exemplary embodiments, the terminal may include two more displays.

FIG. 10B is a schematic diagram of a hardware configuration of a terminal according to an exemplary embodiment. The hardware configuration of the terminal includes a processor 101, a cellular module 102, an input module 103, a display module 104, and a memory 105.

The cellular module 102 bears mobile communication of a terminal 100 by means of accessing an establishment link of a base station. The cellular module 102 may enable the terminal to communicate with another terminal or server by using a network.

The input module 103 may be configured to receive input character information, and generate signal inputs related to user setting and function control. The input module may include a touch surface. The touch surface may collect a touch operation of a user on or near the touch surface (such as an operation of the user on or near the touch surface by using any suitable object or accessory such as a finger or a stylus), obtain a signal brought by the touch operation, convert the signal into contact coordinates, and then send same to the processor 101 for processing, and may receive and execute a command sent by the processor 101.

The display module 104 may be configured to display the function implemented by the processor 101 and related information.

The memory 105 is configured to store an instruction and an application that may be executed by the processor 101, and may further cache data to be processed or processed by the processor 101 and modules in the terminal 100 (such as image data, audio data, voice communications data, and video communications data), and this may be implemented by using a flash or a random access memory 105.

The processor 101 usually controls overall operations of the terminal 100. For example, the input module 103 may be implemented as a touchscreen to output user operating data representing operating characteristics (including contact positions, the number of contacts, and trigger pressure) of the touchscreen to the processor 101. The processor 101 may parse the user operating data to determine a function triggered by the user in the display interface, and generate display data corresponding to the triggered function, so that the display module 104 loads a page corresponding to the triggered function.

It should be noted that in the exemplary embodiments, when the web page running method is implemented in a form of a software functional module and sold or used as an independent product, the web page running method may alternatively be stored in a computer-readable storage medium. Based on such an understanding, the technical solutions of the exemplary embodiments essentially, or the part contributing to the related art technology may be reflected in a form of a software product. The computer software product is stored in a storage medium and includes several instructions for instructing a computer device (which may be a personal computer, a server, a network device, or the like) to perform all or a part of the methods of various exemplary embodiments. The foregoing storage medium includes: any medium that may store program codes, such as a USB flash drive, a removable hard disk, a read-only memory (ROM), a magnetic disk, or an optical disc. In this way, the exemplary embodiments are not limited by any combination of specific hardware and software.

Correspondingly, an exemplary embodiment further provides a computer storage medium, the computer storage medium storing computer executable instructions, and the computer executable instructions being used to perform the web page running method according to the exemplary embodiments.

It should be noted that the description of the foregoing terminal exemplary embodiment or storage medium exemplary embodiment is similar to the description of the foregoing method, and the terminal exemplary embodiment or storage medium exemplary embodiment has beneficial effects the same as those of the method exemplary embodiment. A person skilled in the art should refer to the description of the method exemplary embodiment for understanding of the technical details that are not disclosed in the terminal exemplary embodiment or the storage medium exemplary embodiment.

It should be understood that “one exemplary embodiment” or “an exemplary embodiment” mentioned in the overall specification means that specific features, structures, or attributes related to the exemplary embodiment are included in at least one exemplary embodiment. Therefore, “in one exemplary embodiment” or “in an exemplary embodiment” that occurs in various parts of the specification does not necessarily refer to the same exemplary embodiment. In addition, the specific features, structures, or attributes may be combined in one or more exemplary embodiments in any suitable manner. It should be understood that sequence numbers of the foregoing processes do not mean execution sequences in various exemplary embodiments. The execution sequences of the processes should be determined according to functions and internal logic of the processes, and should not be construed as any limitation on the implementation processes of the exemplary embodiments. The sequence numbers of the foregoing exemplary embodiments are merely for the convenience of description, and do not imply the preference among the exemplary embodiments.

It should be noted that, in this specification, the terms “include”, “comprise”, and any variants thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. Unless otherwise specified, an element limited by “include a/an...” does not exclude other same elements existing in the process, the method, the article, or the device that includes the element.

In the several exemplary embodiments provided in this application, it should be understood that the disclosed apparatus and method may be implemented in other manners. The described device exemplary embodiments are merely exemplary. For example, the unit division is merely logical function division and may be other division during actual implementation. For example, multiple units or components may be combined or integrated into another system, or some features may be ignored or not performed. In addition, the displayed or discussed mutual couplings or direct couplings or communication connections between the components may be implemented through some interfaces, indirect couplings or communication connections between the devices or units, or electrical connections, mechanical connections, or connections in other forms.

The units described as separate parts may or may not be physically separate, and the parts displayed as units may or may not be physical units, may be located in one position, or may be distributed on a plurality of network units. A part of or all of the units may be selected to achieve the objectives of the solutions of the exemplary embodiments. In addition, functional units in the exemplary embodiments may be integrated into one processing unit, or each of the units may exist alone physically, or two or more units may be integrated into one unit. The integrated unit may be implemented in the form of hardware, or may be implemented in the form of hardware and a software functional unit.

A person of ordinary skill in the art may understand that all or some of the steps of the foregoing method exemplary embodiments may be implemented by using a program instructing relevant hardware. The foregoing program may be stored in a computer readable storage medium. When the program is executed, steps of the foregoing method exemplary embodiments are performed. The foregoing storage medium includes: any medium that may store program codes, such as a mobile storage device, a ROM, a magnetic disk, or an optical disc. Alternatively, when the foregoing integrated unit of the present disclosure is implemented in a form of a software functional module and sold or used as an independent product, the integrated unit may be stored in a computer-readable storage medium. Based on such an understanding, the technical solutions of the exemplary embodiments essentially, or the part contributing to the related art technology may be reflected in a form of a software product. The computer software product is stored in a storage medium and includes several instructions for instructing a computer device (which may be a personal computer, a server, a network device, or the like) to perform all or a part of the methods of various exemplary embodiments. The foregoing storage medium includes: any medium that may store program code, such as a mobile storage device, a ROM, a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the appended claims.

According to the exemplary embodiments, by obtaining a first operation on a first page, recording state information of the first page in response to the first operation and obtaining a second page, redirecting to the second page from the first page, obtaining a second operation on the second page, the second operation being used to end the second page, and redirecting to the first page from the second page according to the state information of the first page in response to the second operation, the first page to which a terminal redirects is still in a state in which the first page is previously ended, and a user may continue to view or operate the first page in the state, thereby improving user experience.

What is claimed is:

1. A method comprising:
obtaining, by a terminal that supports only single-window display in which a page is fully displayed on a display interface of the terminal in a full screen manner, a first operation on a first page;
in response to the first operation, recording state information of the first page and obtaining a second page;
redirecting to the second page from the first page;
obtaining a second operation on the second page, the second operation for ending the second page; and
in response to the second operation, redirecting to the first page from the second page according to the state information that is recorded.

2. The method according to claim 1, wherein before the obtaining the first operation, the method comprises:
controlling the first page to be fully displayed on the display interface in the full-screen manner.

3. The method according to claim 1, wherein the redirecting to the first page comprises:
in response to the second operation, generating a first request to request a first server to return a first response, and transmitting the first request to the first server;
receiving the first response from the first server, the first response triggering the terminal to redirect to the first page from the second page; and
redirecting to the first page from the second page according to the state information of the first page.

4. The method according to claim 1, wherein before the obtaining the second operation, the method comprises:
obtaining a third operation from the second page in a first state in which the second page is loaded with a payment information input request, the third operation being a payment information confirmation input operation;
generating a payment request in response to the third operation, and transmitting the payment request to a second server, the payment request requesting the second server to perform a payment service;
receiving a payment response from the second server, the payment response including a payment result from the second server; and
controlling, according to the payment response, the second page to be updated from the first state to a second state in which the second page is loaded with the payment result; and
the obtaining the second operation comprises obtaining the second operation on the second page in the second state.

5. The method according to claim 4, wherein the receiving the payment response comprises:
receiving the payment response through an external communications interface, controlling the external communications interface to send the payment response to the second page, and controlling the second page to send the payment response to the first page; and
updating the first page from a third state to a fourth state according to the payment response after the redirecting to the first page from the second page, wherein the third state is a state in which the first page is loaded with the state information, and the fourth state is a state in which the first page in the third state is loaded with the payment result corresponding to the payment service.

6. The method according to claim 1, wherein before the obtaining the first operation, the method further comprises:
obtaining a fourth operation on a third page, the fourth operation triggering the terminal to obtain a web game page as the first page;
controlling, in response to the fourth operation, the third page to invoke a game framework, and controlling the game framework to send, to a third server, a second request for instructing the third server to return game data;
receiving the game data from the third server, and controlling the game framework to load the game data to obtain the web game page; and
redirecting to the web game page from the third page.

7. The method according to claim 2, wherein the first page is a page on a first application, and after the controlling the first page to be displayed on the display interface in the full-screen manner, the method further comprises:
obtaining a fifth operation on a notification bar of the terminal, wherein the fifth operation is an operation of entering a fourth page on which a notification message on the notification bar is located, and the fourth page is a page on a second application;
recording state data of the first page in response to the fifth operation and obtaining the fourth page;
controlling the display interface to redirect to the fourth page from the first page;
obtaining a sixth operation on the display interface; and
controlling, in response to the sixth operation and according to the state information of the first page, the display interface to redirect to the first page from the fourth page.

8. The method according to claim 1, further comprising:
stopping running of the first page in response to the first operation.

9. An apparatus comprising:
at least one memory configured to store computer program code; and
at least one processor configured to access the at least one memory and operate according to the computer program code,
wherein the apparatus supports only single-window display in which a page is fully displayed on a display interface of the apparatus in a full screen manner, and
wherein the computer program code includes:,
first obtaining code configured to cause the at least one processor to obtain a first operation on a first page;
first response code configured to cause the at least one processor to, in response to the first operation, record state information of the first page and obtain a second page;
redirecting code configured to cause the at least one processor to redirect to the second page from the first page;
second obtaining code configured to cause the at least one processor to obtain a second operation on the second page, the second operation for ending the second page; and
restoration code configured to cause the at least one processor to, in response to the second operation, redirect to the first page from the second page according to the state information that is recorded.

10. The apparatus according to claim 9, wherein the computer program code further comprises:
display code configured to cause the at least one processor to control the first page to be fully displayed on the display interface in the full-screen manner.

11. The apparatus according to claim 9, wherein
the restoration code is configured to cause the at least one processor to:
in response to the second operation, generate a first request to request a first server to return a first response, and transmit the first request to the first server;
receive the first response from the first server, the first response triggering the apparatus to redirect to the first page from the second page; and
redirect to the first page from the second page according to the state information of the first page.

12. The apparatus according to claim 9, wherein the computer program code further comprises:
third obtaining code configured to cause the at least one processor to obtain a third operation from the second page in a first state in which the second page is loaded with a payment information input request, the third operation being a payment information confirmation input operation;
second response code configured to cause the at least one processor to generate a payment request in response to the third operation, and transmit the payment request to a second server, the payment request requesting the second server to perform a payment service;
first receiving code configured to cause the at least one processor to receive a payment response from the second server, the payment response including a payment result from by the second server;
first update code configured to cause the at least one processor to control, according to the payment response, the second page to be updated from the first state to a second state in which the second page is loaded with the payment result; and
second obtaining code is configured to cause the at least one processor to obtain the second operation on the second page in the second state.

13. The apparatus according to claim 12, wherein the computer program code further comprises second update code, wherein
the first receiving code is configured to cause the at least one processor to receive the payment response through an external communications interface, control the external communications interface to send the payment response to the second page, and control the second page to send the payment response to the first page; and
the second update code is configured to cause the at least one processor to control the first page to be updated from a third state to a fourth state according to the payment response after the redirecting to the first page from the second page, wherein
the third state is a state in which the first page is loaded with the state information, and the fourth state is a state in which the first page in the third state is loaded with the payment result corresponding to the payment service.

14. The apparatus according to claim 9, wherein the computer program code further comprises:
fourth obtaining code configured to cause the at least one processor to obtain a fourth operation on a third page, the fourth operation triggering the terminal to obtain a web game page as the first page;
third response code configured to cause the at least one processor to control, in response to the fourth operation, the third page to invoke a game framework, and control the game framework to send, to a third server, a second request for instructing the third server to return game data;
second receiving code configured to cause the at least one processor to receive the game data from the third server, and control the game framework to load the game data to obtain the web game page; and
redirecting code is configured to cause the at least one processor to redirect to the web game page from the third page.

15. The apparatus according to claim 10, wherein the first page is a page on a first application, and the computer program code further comprises fifth obtaining code, fourth response code, and sixth obtaining code, wherein
the fifth obtaining code is configured to cause the at least one processor to obtain a fifth operation on a notification bar of the terminal, wherein the fifth operation is an operation of entering a fourth page on which a notification message on the notification bar is located, and the fourth page is a page on the second application;
the fourth response code is configured to cause the at least one processor to record state data of the first page in response to the fifth operation and obtain the fourth page;
the redirecting unit code is configured to cause the at least one processor to control the display interface to redirect to the fourth page from the first page;
the sixth obtaining code is configured to cause the at least one processor to obtain a sixth operation on the display interface; and
the restoration code is configured to cause the at least one processor to control, in response to the sixth operation and according to the state information of the first page, the display interface to redirect to the first page from the fourth page.

16. The apparatus according to claim 9, wherein the computer program code further comprises stop code configured to cause the at least one processor to stop running of the first page in response to the first operation.

17. A terminal comprising:
a display;
at least one memory configured to store computer program code; and
at least one processor,
wherein the terminal supports only single-window display in which a page is fully displayed on a display interface of the terminal in a full screen manner, and
wherein the at least one processor is configured to access the at least one memory and operate according to the computer program code to:
obtain a first operation on the first page;
in response to the first options, record state information of the first page and obtain the second page;
control the display to redirect to displaying of the second page from displaying of the first page;
obtain a second operation on the second page, the second operation for ending the second page; and
control, in response to the second operation and according to the state information of the first page, the display to redirect to displaying of the first page from displaying of the second page.

18. The method according to claim 1, wherein redirecting to the second page from the first page ends the first page.

19. The method according to claim 18, wherein redirecting to the first page from the second page comprises opening the first page in a state specified by the state information that is recorded.
